(19) United States
(12) Patent Application Publication
(10) Pub. No.: US 2026/0180050 A1
(43) Pub. Date: Jun. 25, 2026

(54) Device and Method for Automated Discharging of Batteries

(71) Applicant: Robert Bosch GmbH, Stuttgart (DE)

(72) Inventors: Andreas Letsch, Stuttgart (DE); Dietmar Martini, Stuttgart (DE); Dominik Koch, Stuttgart (DE); Dominik Luetke Juedefeld, Muenster (DE); Markus Kohlberger, Stuttgart (DE); Christian Bischoff, Stuttgart (DE)

(21) Appl. No.: 19/423,168

(22) Filed: Dec. 17, 2025

(30) Foreign Application Priority Data
Dec. 20, 2024 (DE) 10 2024 139 155.3

(51) Int. Cl. H01M 10/44

(52) U.S. Cl. CPC H01M 10/448

(57) ABSTRACT

A device for automated discharging of batteries includes (i) power electronics for deep discharging of a battery, (ii) an activation device for activating a switching element, (iii) at least one connection system for electrically connecting and disconnecting an electrical connection of the power electronics to/from the poles of the battery and for connecting the switching element to the poles of the battery, and (iv) a controller for controlling the power electronics, the connection system, and the activation device. The controller is configured to actuate the activation device after the power electronics have completed deep discharging of the battery.

This application claims priority under 35 U.S.C. § 119 to application no. DE 10 2024 139 155.3, filed on Dec. 20, 2024 in Germany, the disclosure of which is incorporated herein by reference in its entirety.

The disclosure relates to a device as well as a method for automated discharging of batteries.

### BACKGROUND

Used electrochemical energy storage devices (used batteries, cells, modules, packs), in particular lithium-ion batteries and sodium-ion batteries, are often subjected to mechanical shredding at the end of their useful life. This process carries the risk of ignition or explosion of battery components as the remaining electrical energy in the batteries may result in an arc that ignites, damages, or even injures living things in the surrounding area.

In lithium-ion and sodium-ion batteries, there is a highly flammable electrolyte in the battery cells, in particular a mixture of ethylene carbonate and dimethyl carbonate, which forms a highly explosive mixture in air. Batteries are therefore discharged or deep discharged to 0 V before mechanical shredding, so that there is no residual electrical voltage and thus the occurrence of arcs or ignition sparks due to residual electrical energy is prevented.

Simple discharging to 0 V and subsequent opening of the poles of the battery often leads to severe voltage relaxation, since the remaining reactants in the electrodes elicit an electrode potential again and thus once again form an electrical voltage on the battery. To prevent this, the battery must be discharged for a very long time or shorted and stored at a certain point. For example, the voltage from controlled power electronics or discharge electronics is discharged to 0 V and held at this level so that the discharging current becomes increasingly smaller. The battery is then shorted by way of a short-circuit bar. Due to the very rapid voltage relaxation, this is also a time-critical process. The short-circuit bar is often left on the poles of the battery during the mechanical shredding process.

The application of short circuits for the disposal or recycling of batteries proves to be problematic. The application of the short circuits, which may be configured as short-circuit bars, for example, is a complex task due to the very high variety of types of batteries available on the market, which usually cannot be automated cost-efficiently. When manually applied, it presents a risk to humans of electric shock, coming into contact with hazardous materials, or suffering burns, as the batteries can heat up severely during deep discharge. Temperatures of over 60° C. can be readily achieved. At the same time, the disconnection from the discharging electronics and the subsequent contacting of the battery poles with the short-circuit bar must occur very quickly; otherwise, a dangerous relaxation voltage will form again. Accordingly, the step of disconnecting from the discharging electronics and the subsequent short-circuit of the battery is not only a time-critical, but also a dangerous, process for humans and thus is of heightened interest for automation.

The disclosure is therefore based on the objective of providing a device and method for automated discharging of batteries.

The problem is solved by the subject-matter set forth below.

### SUMMARY

According to a first aspect of the disclosure, this problem is solved by a device for automated discharging of batteries, wherein the device comprises power electronics for deep discharging of a battery and an activation device for activating a switching element. Furthermore, the device comprises a connection system for electrically connecting and disconnecting an electrical connection of the power electronics to/from the poles of the battery and for connecting the switching element to the poles of the battery, as well as a controller for controlling the power electronics, the connection system, and the activation device. The controller is configured to actuate the activation device after the power electronics have completed deep discharging of the battery.

The power electronics may be any electronics suitable for deep discharging of a battery, in particular a lithium-ion battery or a sodium-ion battery. The term “deep discharge” describes a state in lithium-ion batteries, in which the voltage of a cell has fallen below a critical level, which is typically at about 2.5 volts or less, particularly at 0 V, depending on the specific chemistry of the cell. This condition is extremely harmful to the battery as it may trigger irreversible chemical reactions in the electrode and electrolyte. In a lithium-ion cell, energy is stored and released by reversible storage of lithium ions in the anode and cathode materials. However, with a deep discharge, nearly all lithium ions are removed from the active materials, which may result in the structure of the electrode material becoming destabilized. However, this step is very important for recycling so that when the battery is shredded, there are no arcs due to residual voltage.

The switching element is preferably configured to be activated at any moment by the activation device. It may further be connected to the battery via cables or wires to provide some distance from the battery. This is particularly advantageous because the battery can get hot or swell during deep discharging. Due to the distance, persons present may be better protected and can interact with the switching element without having to unnecessarily get close to the battery.

The connection system is a system that can be used to electrically connect the power electronics and the activation device to the battery. The connection is preferably made via battery-side contacts, that is, the poles of the battery. The connection system is configured to bring the contacts of the power electronics and the activation device into contact with the contacts of the battery to thus allow current to flow.

The switching element does not interfere with the deep discharging of the battery as long as it is not activated. Upon activation, it can be changed from a non-conductive state to a conductive state such that a short circuit is established between the poles of the battery. The short circuit ensures that any voltage relaxation between the cells of the battery cannot build up but flows as a current.

The controller may be formed by a control unit, in particular a microcontroller or other central control element for industrial robots. The controller is set to drive the activation device for the switching element only after deep discharging of the battery. The present disclosure thus enables very simple and cost-efficient automation of the short circuiting of batteries after completing deep discharging. If the switching element is configured as an inexpensive variant and consists of easily recyclable material, it can be added to the recycling process. For example, an automotive fuse holder or fuse socket having a fuse to be inserted by the activation device may be used as a switching element.

The device is thus suitable to perform an automated method of discharging batteries, and therefore it solves the problem.

In one embodiment, the connection system comprises at least two robotic arms. The robotic arms are configured to connect the power electronics and the switching element to the poles of the battery.

A robotic arm as defined in terms of the disclosure is a system configured to receive control commands from a controller and translate them into mechanical motion. To this end, a robotic arm may comprise one or more pneumatic and/or hydraulic systems, motors, in particular electric motors, as well as actuators. The robotic arms are further configured to connect the power electronics and the switching element to the poles of the battery. For example, the connection may be a form-fitting and/or force-fitting connection, an adhesive connection, a weld or seam, or another suitable connection that allows for and does not restrict the flow of current.

Preferably, the power electronics are connected to the battery via a disconnectable connection, for example, a terminal or by pressing the contacts, so that the connection can be easily disconnected after completing deep discharging. The switching element may remain on the battery by permanently connecting it to the battery, for example, with a weld or solder point. The robotic arms are in any case configured to make this connection. For example, the robotic arms may comprise grippers or weld or solder tips for connecting the power electronics and the switching element to the battery.

In one embodiment, the power electronics and/or the switching device are connectable to the poles of the battery via contacts, and the connection system comprises a sensor system for positioning the contacts of the power electronics and/or the switching device on the poles of the battery.

The sensor system is used to sense the environment of the connection system. For example, if the connection system comprises one or more robotic arms, a sensor system may be installed in the robotic arms. Alternatively, the sensor system may comprise a static position in the device for discharging the battery, although it is still associated with the connection system, as this increases the precision of controlling the connection system.

The sensor system may observe and provide data to the controller about the connection system as it operates. The controller may then drive the connection system such that the contacts of the power electronics and the switching element are moved towards the poles of the battery. The controller may generate iterative or continuous control signals, depending on the type of control.

The sensor system may consist of one or more sensors. Suitable sensors may be, for example, optical sensors, in particular cameras, IR sensors, UV sensors, radar, or lidar sensors. Sound or ultrasonic sensors may also be used.

In one embodiment, the controller comprises a module for controlling the connection system, wherein the module for controlling the connection system comprises a machine learning algorithm for detecting the position of the contacts on the battery from the sensor data of the sensor system.

The machine learning algorithm processes the sensor data of the sensor system, which is preferably an imaging sensor system. Accordingly, a model suitable for processing image data should be chosen. For example, the machine learning algorithm may therefore be a convolutional neural network (CNN).

The module is operated by the controller, but does not necessarily need to be trained by the controller. For example, the machine learning algorithm may already be provided in a trained state. If the control system has sufficient computational resources, the machine learning algorithm may also be trained in situ and self-monitored to counteract, for example, data drift or to detect failures early during operation of the proposed device.

In one embodiment, the switching element is configured to be switched from an electrically non-conductive state to an electrically conductive state.

The conductive state is a state in which the switching element shorts the poles of the battery. Prior to that, the switching element is in a non-conductive state so that its contacts can be readily connected to the poles of the battery. The state is not switched until deep discharging of the battery has been completed to prevent voltage relaxation. The switching element can be configured such that the switching operation is not reversible. This is because, especially when the switching element is recycled with the battery, it does not have to be reset from the conductive state to the non-conductive state.

In one embodiment, the switching element comprises a mechanical switch, an electronic switch, a fuse, an electrochemical element, and/or a thermoelectric element. Alternatively, the switching element may be a loose power cable with a suitable cross section, which is initially only fixedly connected or contacted at one of the poles of the battery. After fully discharging, the other end of the power cable may be connected to the other pole of the battery and thus the terminals of the battery may be shorted.

For example, an electronic switch may be a transistor or another switch that is electronically controllable to switch an electrical connection between the poles of the battery. Electronic switches are typically cheap and can be manufactured as bulk products using few resources.

A fuse is a particular form of a switch that can change from a conductive to a non-conductive state at a current flow of defined magnitude. The fuse may be changed from the non-conductive state to the conductive state by being inserted into a corresponding receptacle, for example, a socket. The activation device may then be configured as, for example, an actuator inserting the fuse into the socket.

A fuse also has the advantage that it can be used to check whether the short-circuit current, which can still flow for some time between the poles of the battery due to voltage relaxation voltage, is too high and would thereby heat the battery too much. If a current flows, the battery is not yet fully discharged or deactivated. The fuse may be sized to change to the non-conductive state at dangerously high currents.

Furthermore, electrochemical or thermoelectric elements may be used as switching elements, which may be switched from the non-conductive to the conductive state due to a chemical reaction or change in temperature.

In one embodiment, the activation device comprises a linear actuator. The linear actuator is configured to switch the switching element from the non-conductive state to the conductive state.

For example, a linear actuator may be used to cause mechanical shifting of the switching element by way of linear motion. This may comprise, for example, turning a switch or inserting a fuse.

In a further aspect, the disclosure relates to a method for automated discharging of batteries having a device as described above, wherein the method comprises the steps of:
electrically connecting the power electronics to the poles of the battery;
discharging the battery to a discharge voltage with the power electronics; in this case, it may be advantageous to maintain the discharge voltage at the discharging voltage (approx. 0 V) for a certain amount of time by way of a current regulator before the switching element is activated and the external short circuit of the battery poles takes place. The short-circuit current can thus be reduced.
electrically connecting the switching element to the poles of the battery;
shorting the battery by activating the switching element with the activation device after the voltage of the battery has reached the discharging voltage; and
electrically disconnecting the power electronics from the battery after shorting or during shorting of the battery.

So far, the side of the device according to the disclosure has been illuminated. The appropriate method is considered below.

First of all, the power electronics are connected to the battery, or more specifically, to its poles. This connection causes deep discharging of the battery. Furthermore, the switching element is connected to the poles of the battery. This may be done together with the connection of the power electronics or during deep discharge.

The switching element is in a non-conductive state at the time of connection to the poles of the battery to prevent the battery from being shorted immediately. Therefore, it does not matter when exactly the switching element is electrically connected to the poles of the battery. However, the switching element must be electrically connected to the battery before disconnecting the power electronics, as this is a time-critical moment. The time interval between disconnecting the power electronics from the battery or the end of the active deep discharge and the associated removal of the residual energy and the short circuit should be as small as possible so that no, or at least as little as possible, voltage relaxation occurs.

When discharging, it may be advantageous to maintain the discharge voltage at approximately 0 V by way of a current regulator for a certain amount of time before the switching element is activated and the external short circuit of the battery poles thus takes place. In this way, the short-circuit current can be reduced.

The connection of the power electronics and/or the switching element to the poles of the battery can preferably be carried out by a connection system, in particular by robotic arms or actuators. The short circuit, on the other hand, can be carried out in different ways. For example, an electronic switching element may be used that is electronically switched to a conductive state. Alternatively, for example, a fuse may be used that is inserted into a socket to short the circuit.

Each of the steps mentioned is automatable so that the discharging process of the battery no longer needs to be performed by a person who is exposed to the risk of an igniting battery. This aspect of the disclosure thus solves the problem at hand.

In one embodiment, the electrical connection of the switching element and the power electronics to the poles of the battery occurs simultaneously by way of the connection system.

In this embodiment, the connection system comprises two or more robotic arms each connecting a contact for the power electronics and the switching element to a pole of the battery. The contact may be such that a point of contact for the switching element is connected to the battery in a form-fitting or force-fitting manner, with adhesive or by welding to the pole of the battery. The contact to the power electronics is connected with a reversible connection, for example by pressing or clamping.

The simultaneous connection may advantageously reduce the number of systems needed for the connection system, since only one contact system is required for each pole. For batteries of uniform size, the number of systems may even be reduced to one system, for example, when a robotic arm handles both poles simultaneously or sequentially.

In one embodiment, the electrical connection of the power electronics and the switching element to the battery is preceded by positioning the connection system at the poles of the battery.

The connection system is first positioned in this embodiment. That is to say, the connection system is not simply directed in a linear manner towards the poles. Instead, an active controller is used to enable the contact of the power electronics and the switching element with the battery poles to occur in two or three dimensions.

As a result, for example, the connection system may respond to different types of batteries or designs and models. A controller may be used to control the connection system, as is commonly used for industrial robots.

In one embodiment, the connection system comprises two robotic arms, with each robotic arm comprising a sensor system. Positioning the connection system comprises the steps of:
sensing the position of contacts of the battery with the sensor systems;
generating control commands for controlling the robotic arms; and
leading the contacts of the power electronics and the switching element to the contacts of the battery by executing the control commands.

A sensor system may be used to improve the positioning of the connection system. This may sense the entire device or only the connection system or individual robotic arms. Alternatively, the sensor system or individual sensors may be integrated in the robotic arms, for example.

First, the position of the contacts of the battery is sensed. The contacts of the battery are the poles. Control commands are generated from the relative position of the robotic arms and the contacts, with which the robotic arms are driven. The robotic arms are then positioned to connect the power electronics and the switching element to the contacts of the battery.

Advantageously, by using the sensor data to generate control commands, the precision with which the robotic arms connect the power electronics and the switching element to the poles of the battery can be increased.

In one embodiment, the disconnection of the power electronics is preceded by measuring the voltage at the switching element. The power electronics are not electrically disconnected from the battery until the voltage at the switching element is zero volts.

The battery voltage can be checked at the switching element. If the voltage is greater than 0 V, this is an indicator that the switching element has not yet been fully switched to the conductive state, for example, because it has not been activated correctly. For example, if the switch element is a fuse, the fuse may not be seated correctly in the socket. Furthermore, the switching element itself may be defective or exhibit a defect. In any case, a remaining voltage in the battery may result in an arc during the further recycling process, which in turn poses a hazard.

Conducting a voltage measurement prior to disconnecting the power electronics, therefore, advantageously increases the safety of recycling the battery.

In one embodiment, the control commands for the connection system are generated by a machine learning algorithm.

In another aspect, the disclosure relates to a computer-implemented method for training a system for controlling a device for automated discharging of batteries, wherein the method comprises the steps of.
providing a battery having two electrical contacts, wherein the contacts are detectably marked for a sensor system;
sensing position data of the battery and position data of the contacts with the sensor system;
generating control commands for positioning robotic arms of a connection system on contacts of the battery based on the position data of the battery using a machine learning algorithm;
controlling the robotic arms with the generated control commands;
determining a loss function based on the position of the robotic arms after controlling them and the position data of the contacts;
training the machine learning algorithm according to the result of the loss function; and
providing the trained machine learning algorithm to generate control commands for the robotic arms.

The machine learning algorithm is particularly trained to recognize the battery, its type, or model, and accordingly identify the location of its contacts. The ultimately provided machine learning algorithm is intended to be able to detect the contacts without the marking.

The markings are affixed to the contacts to be used as ground truth. If the sensor system comprises optical sensors, the markings may comprise optical, in particular visual markings, for example color highlighting.

The machine learning algorithm may be trained in use in this manner as long as batteries having a corresponding marking on the contacts are provided. Since the contacts are affixed before deep discharging or even contacting the battery, attaching contacts does not pose too much of a risk to a marking person or a corresponding automatic system.

In a further aspect, the disclosure relates to a computer program having a program code for performing a method for automated discharging of batteries when the computer program is executed on a computer.

In a further aspect, the disclosure relates to a computer program having a program code for performing a method for training a system to control a device for automated discharging of batteries when the computer program is executed on a computer.

In a further aspect, the disclosure relates to a computer-readable data carrier having a program code of a computer program for performing a method for automated discharging of batteries when the computer program is executed on a computer.

In a further aspect, the disclosure relates to a computer-readable data carrier having a program code of a computer program for performing a method for training a system to control a device for automated discharging of batteries when the computer program is executed on a computer.

Overall, a device for automated discharging of batteries, a method for automated discharging of batteries, a computer-implemented method for training a system for controlling a device for automated discharging of batteries, and a corresponding computer program and computer-readable data carrier with program code are presented.

The described embodiments and refinements may be combined with one another as desired.

Further possible embodiments, refinements and implementations of the disclosure also comprise combinations of features of the disclosure described previously or below with regard to the exemplary embodiments that are not explicitly mentioned.

### BRIEF DESCRIPTION OF THE DRAWINGS

The accompanying drawings are intended to provide a better understanding of the embodiments of the disclosure. They illustrate embodiments and, in connection with the description, serve to explain principles and concepts of the disclosure.

Other embodiments and many of the advantages mentioned are shown in the drawings. The illustrated elements of the drawings are not necessarily shown to scale with respect to one another.

It shows:

FIGS. 1a-f schematically illustrate the flow of a method for automated discharging of batteries with a corresponding device;

FIG. 2 a portion of a device for automated discharging of batteries.

In the figures of the drawings, identical reference numbers denote identical or functionally identical elements, parts or components, unless stated otherwise.

### DETAILED DESCRIPTION

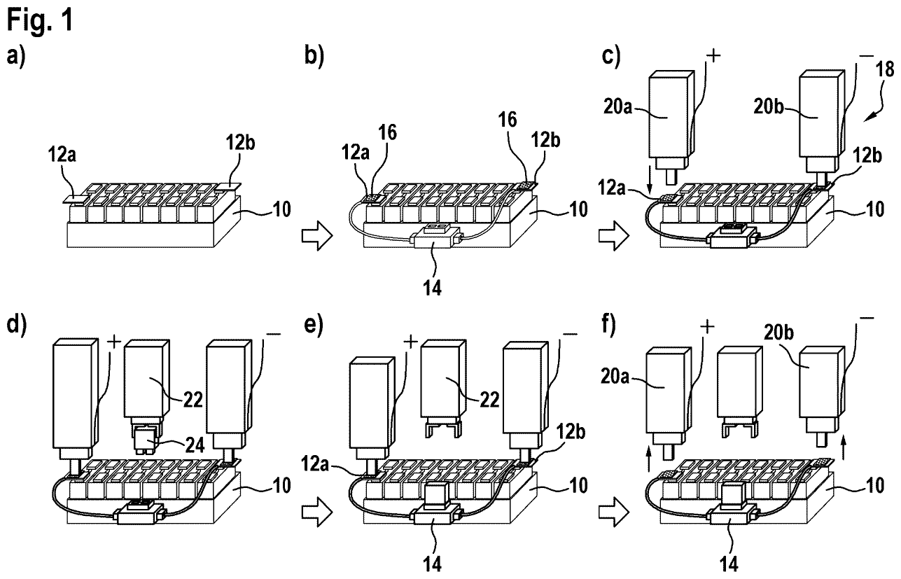

FIGS. 1a-1f schematically illustrate the automated discharging of a battery 10. FIG. 1a shows the battery 10 with two poles 12a and 12b, which are used as battery-side contacts in the later process.

In FIG. 1b, a switching device 14 is electrically connected to the battery 10 via poles 12a and 12b. Also, markings 16 have been applied to the poles 12a and 12b to simplify further contacting. The switching device 14 in the illustrated embodiment consists of a fuse and a fuse socket. The fuse socket is already connected to the battery in FIG. 1b. The switching device is activated by inserting the fuse into the fuse socket.

In FIG. 1c, a connection system 18 approaches the battery. In the illustrated embodiment, the connection system comprises two robotic arms 20a and 20b. The robotic arms 20a and 20b are connected to positive and negative contacts of power electronics (not shown here) for discharging the battery 10. The robotic arms 20a and 20b are connected to the poles 12a and 12b, respectively, to electrically connect the battery 10 to the power electronics.

In FIG. 1d, the battery 10 is discharged. During the discharging process, an activation device 22, shown here as a linear actuator with a gripping arm, is used to move and insert a fuse 24 into the fuse socket once the battery 10 is discharged. This is illustrated in FIG. 1e. The activation device 22 has thus fulfilled its task and can be retracted. The switching device 14, comprising the fuse 24 in the fuse socket, is now in an electrically conductive state and briefly shorts the poles 12a and 12b. The remaining voltage between the poles 12a and 12b can thus dissipate via the fuse. Voltage relaxation between the poles 12a and 12b is thus prevented.

FIG. 1f shows the shorted battery 10 with the switching element 14. The robotic arms 20a and 20b are no longer needed. With their retraction, the battery 10 is separated from the power electronics. The battery 10 is now discharged and can be recycled.

FIGS. 1a to 1f in particular show one embodiment in which the markings 16 can be used to be sensed by a sensor system not shown here. The data may be used to train a machine learning algorithm to identify the battery 10, the battery type and/or the battery model, and generate appropriate control commands for the connection system.

In alternative embodiments, the fuse socket is electrically connected to the robotic arms 20a and 20b and to the poles 12a and 12b to establish connection of the power electronics and the switching element 14 simultaneously with the battery 10 and not successively as indicated in FIGS. 1a to 1e.

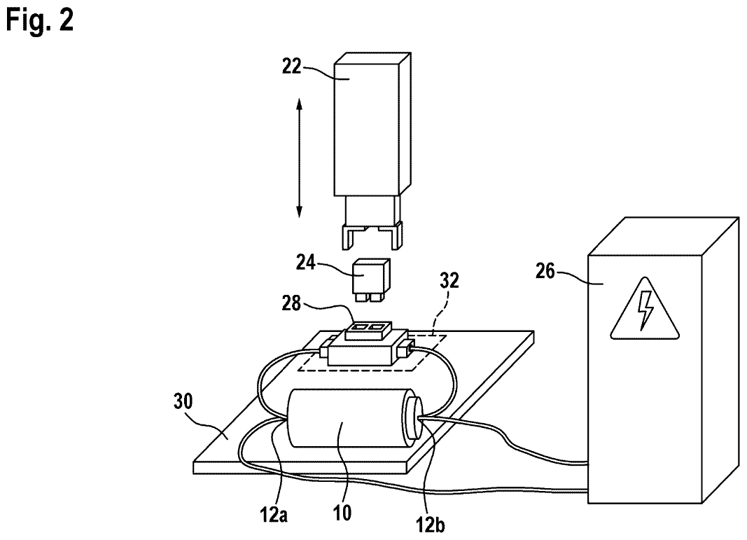

FIG. 2 shows a variant of the disclosure. During contacting with power electronics 26, an open cable connection, preferably a cable with an open automotive fuse socket 28 for flat fuses, is already attached to poles 12a and 12b of battery 10. This cable with the open fuse socket 28 may be attached to poles 12a and 12b of the battery 10 by way of spot welding, gluing, bolting, or clamping.

In this automated solution, two variants can be differentiated. In the illustrated variant, the transport of the battery 10 occurs on a part carrier 30. Alternatively, the method may be performed without a part carrier 30. Since this second variant is shown essentially in FIGS. 1a to 1f, it will not be described in more detail below.

The part carrier 30 and its use advantageously cause the battery 10 to not need to be directly handled after being discharged, in order to move it. As batteries get hot, inflate, and become unstable, using the part carrier increases safety when handling the battery 10 in a deeply discharged state.

The fuse socket is fixedly attached to the part carrier 30 at a defined location, advantageously adjacent to or on the battery 10. In addition to the battery 10, the fuse socket 28 can be mechanically fixed, for example, by way of a releasable clamping or screwing device. The fuse socket 28 may be clamped, bolted, or glued to the battery 10. A glued fuse socket 28 may remain on the battery 10.

When attaching to the part carrier 30, it should be noted that it is often desired to include the short-circuit bar in the recycling for safety reasons. The switching element should thus be easy to loosen again, since the part holder 30 is usually not to be sent for mechanical shredding.

The fuse 24 is inserted into the fuse socket 28 after deep discharge by way of a linear actuator 22, which is equipped with a suitable gripper. The same location is always selected so that there is no need for movement in the x or y direction in parallel to the part carrier 30. This location may also be labeled with a marking 32 for training a machine learning algorithm. In addition, a compensation module may be attached to the linear actuator 30 to compensate for minor local deviations of the open fuse socket 28.

What is claimed is:

1. A device for automated discharging of batteries, comprising:
power electronics configured to deep discharge a battery;
an activation device configured to activate a switching element;
at least one connection system configured to electrically connect and disconnect an electrical connection of the power electronics to/from poles of the battery and to connect the switching element to the poles of the battery; and
a controller configured to control the power electronics, the connection system, and the activation device, wherein the controller is configured to actuate the activation device after the power electronics have completed deep discharging of the battery.

2. The device according to claim 1, wherein the connection system comprises at least two robotic arms, and wherein the robotic arms are configured to connect the power electronics and/or the switching element to the poles of the battery.

3. The device according to claim 1, wherein the power electronics and/or the switching device are connectable to the poles of the battery via contacts, and wherein the connection system comprises a sensor system configured to position the contacts of the power electronics and/or the switching device at the poles of the battery.

4. The device according to claim 3, wherein the controller comprises a module configured to control the connection system, wherein the module comprises a machine learning algorithm for detecting the position of the contacts on the battery from the sensor data of the sensor system.

5. The device according to claim 1, wherein the switching element is configured to be switched from an electrically non-conductive state to an electrically conductive state.

6. The device according to claim 5, wherein the switching element comprises a mechanical switch, an electronic switch, a fuse, an electrochemical element, and/or a thermoelectric element.

7. The device according to claim 5, wherein the activation device comprises a linear actuator, and wherein the linear actuator is configured to switch the switching element from the non-conductive state to the conductive state.

8. A method for automated discharging of batteries with the device according to claim 1, comprising:
electrically connecting the power electronics to the poles of the battery;
discharging the battery to a discharge voltage with the power electronics;
electrically connecting the switching element to the poles of the battery;
shorting the battery by activating the switching element with the activation device after the voltage of the battery has reached the discharge voltage; and
electrically disconnecting the power electronics from the battery after shorting or during shorting of the battery.

9. The method according to claim 8, wherein the electrical connection of the switching element and the power electronics to the poles of the battery occurs simultaneously by way of the connection system.

10. The method according to claim 8, wherein the electrical connection of the power electronics and the switching element is preceded by a positioning of the connection system on the poles of the battery.

11. The method according to claim 10, wherein the connection system comprises two robotic arms and, for each robotic arm, a sensor system, and wherein positioning of the connection system comprises:
sensing the position of the contacts of the battery with the sensor systems;
generating control commands for controlling the robotic arms; and
leading the contacts of the power electronics and the switching element to the contacts of the battery by executing the control commands.

12. The method according to claim 8, wherein:
disconnection of the power electronics is preceded by measuring the voltage at the switching element, and the power electronics are not electrically disconnected from the battery until the voltage at the switching element is zero volts.

13. A computer-implemented method for training a system for controlling a device for automated discharging of batteries, comprising:
providing a battery having two electrical contacts, wherein the contacts are detectably marked for a sensor system;
sensing position data of the battery and position data of the contacts with the sensor system using the markings;
generating control commands for positioning robotic arms of a connection system on contacts of the battery based on the position data of the battery using a machine learning algorithm;
controlling the robotic arms with the generated control commands;
determining a loss function based on the position of the robotic arms after controlling them and the position data of the contacts;
training the machine learning algorithm according to the result of the loss function; and
providing the trained machine learning algorithm to generate control commands for the robotic arms.

14. A computer program having a program code to execute the method according to claim 8, when the computer program is executed on a computer.

15. A computer-readable data carrier having program code of a computer program for performing the method according to claim 8, when the computer program is executed on a computer.

16. The computer program having a program code to execute the method according to claim 13, when the computer program is executed on a computer.

17. A computer-readable data carrier having program code of a computer program for performing the method according to claim 13, when the computer program is executed on a computer.
